(19) United States
(12) Patent Application Publication
(10) Pub. No.: US 2009/0202226 A1
(43) Pub. Date: Aug. 13, 2009

(54) SYSTEM AND METHOD FOR CONVERTING ELECTRONIC TEXT TO A DIGITAL MULTIMEDIA ELECTRONIC BOOK

(75) Inventor: Martin McKay, Belfast (IE)

Correspondence Address: SEYFARTH SHAW LLP, WORLD TRADE CENTER EAST, TWO SEAPORT LANE, SUITE 300, BOSTON, MA, 02210-2028, US

(73) Assignee: Texthelp Systems, Ltd., Antrim (IE)

(21) Appl. No.: 11/916,500

(22) PCT Filed: Jun. 6, 2006
(86) PCT No.: PCT/IB06/02424

§ 371 Date: Sep. 11, 2008

Related U.S. Application Data
(60) Provisional application No. 60/687,785, filed on Jun. 6, 2005.

(51) Int. Cl. H04N 5/91; G10L 13/08

(52) U.S. Cl. 386/104; 704/260

(57) ABSTRACT

A system and method for converting an existing digital source document into a speech-enabled output document and synchronized highlighting of spoken text with the minimum of interaction from a publisher. A mark-up application is provided to correct reading errors that may be found in the source document. An exporter application can be provided to convert the source document and corrections from the mark-up application to an output format. A viewer application can be provided to view the output and to allow user interactions with the output.

### CROSS REFERENCE TO RELATED APPLICATIONS

The present invention claims priority to U.S. Provisional Patent Application No. 60/687,785 filed on Jun. 6, 2005 which is incorporated herein by reference in its entirety.

### FIELD OF THE INVENTION

The present invention relates to the field of data processing and more particularly to the field of text to speech processing.

### BACKGROUND OF THE INVENTION

Currently known methods to provide a speech-enabled talking book include technologies for speech streaming from media without synchronisation, speech streaming from media with synchronisation and deploying a text-to-speech engine.

Methods of speech streaming without synchronisation provide speech-enabled talking books by recording speech either from a text-to-speech engine or by recording a human voice from an actor or other voiceover artist and saving the output as a digital audio file. A user interface is then typically constructed for the speech-enabled book to permit a user to listen to spoken text.

Methods of speech streaming with synchronisation provide speech-enabled talking books in generally the same manner as the speech without synchronisation except that additional calculations are performed to synchronise timing of the speech. Calculations for the synchronisation of spoken words in the audio are usually performed manually and the time codes (time offsets from the start of speech) for each word are recorded. At playback time, the time offsets can be used to calculate which word to highlight at any given time.

Methods of speech streaming by deploying a text-to speech engine provides a more technical solution for developing talking books. A talking book program which can be distributed to each user or reader can include a high quality text-to-speech engine. Text can be sent to the speech engine on the user's local computer and output can be provided to the computer's wave output device (via speakers, headphones etc.). Highlighting of individual words can be achieved using information returned ‘live’ from the speech engine.

The existing methods of providing speech-enabled talking books have drawbacks which make their implementation cumbersome and/or expensive.

Providing speech streamed from media without synchronisation is generally a simple way to implement a talking book. However, this method provides computer-generated static speech which is generally not easily customisable. Text-to-speech engines can pronounce words incorrectly, and the content creator will not have control over individual pronunciations on a page. This method generally does not provide visual feedback to the user to indicate which word is being spoken and can be difficult and expensive to implement. Either an expensive technical method is used to provide a voice or an expensive voice-over artist is generally employed. If a recorded human voice is used then it either cannot be varied (reading speed, gender etc.) or more than one voice artist must be employed to record the audio multiple times.

Providing speech streamed from media with synchronisation suffers many of the same drawbacks of unsynchronised methods such as the drawbacks of non-customisable speech and the possible expense of employing voice artists. Additionally, current systems generally require that the timing of every word spoken by either the computer voice or the voice artist is calculated and recorded manually. Accordingly this method can be very labour-intensive.

Deploying a text to speech engine can be disadvantageous because developing such systems involves substantial technical overhead. For example, custom software must generally be developed to handle the speech, highlighting and word synchronisation. Furthermore, high quality text-to-speech engines generally require a royalty payment per desktop. This quickly becomes expensive for larger distributions. A separate speech engine and program to drive the speech are required in current implementations of text-to-speech engines on both Windows and Macintosh platforms.

### SUMMARY OF THE INVENTION

Embodiments of the present invention provide a system and method for converting an existing digital source document into a speech-enabled output document and synchronized highlighting of spoken text with the minimum of interaction from a publisher. A mark-up application is provided to correct any reading errors (flow, pronunciation etc.) that may be found in the source document. An exporter application can be provided to convert the source document and corrections from the mark-up application to an output format. A viewer application can be provided to view the output. The viewer application can be a custom application to view the output in Macromedia Flash in a web environment, for example, or in a proprietary multimedia format.

An illustrative embodiment of the present invention provides a system for converting information into speech. The system includes a mark-up application receiving a source file. The mark-up application provides a publisher interface for adding flow information to the source file to provide a marked up file. An exporter application receives the marked up file and generates audio files, time code information and image files therefrom. In an illustrative embodiment, the exporter application can combine the audio files, time code information and image files to generate a multimedia file. In an alternative embodiment, the exporter application can combine the audio files, time code information and image files for user interaction in a viewer application such as a multimedia flash application.

Another illustrative embodiment of the invention provides a method for converting information into speech. The method includes the steps of providing a publisher for receiving a source file and adding speech flow information to the source file to form a marked up file. The illustrative method includes the further steps of generating an audio file, time code information, and an image file from the marked up file and combining the audio file, time code information and image file to generate an audiovisual output including a spoken representation of the source file and a viewable representation of the source file.

In the illustrative embodiments, flow information can include paragraph breaks, sentence breaks, reading order of text in the source file and the like. In addition to providing for the addition of flow information to a source file, the markup application can be used to modify pronunciation of words in the source file and/or to add words, for example, to describe non-text elements of the source file. In the illustrative embodiments, time code information can include a time for each word or phoneme to be spoken relative to a common reference time.

The viewable representation of a source file can include text portions that are highlighted in synchronization with the spoken representation. Audiovisual output can include an multimedia file or may include output adapted for a viewer application. Illustrative embodiments of the present invention provide a viewer application having an interface which allows user interaction with the audiovisual output.

Embodiments of the present invention include several features and advantages over heretofore known technologies. For example, embodiments of the system and method of the present invention do not require installation of client software and are platform-independent. The embodiments allow a ‘publisher’ to specify reading order and pronunciation of words. Speech synchronisation information can be generated without further user interaction. Text in a viewed document can be highlighted as it is spoken for the end user. It is not necessary to incur costs of royalty for voice-over speech. No specialized technical knowledge of speech technology or programming is required to use the presently described system and method.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a schematic representation which identifies the main elements of a typical page to be converted to speech according to illustrative embodiments of the present invention;

FIG. 2 is a process flow diagram of a speech-to-text system according to an illustrative embodiment of the present invention;

FIG. 3 is an example of a representation of document object model that can be used to extract text from a document according to illustrative embodiments of the present invention;

FIG. 4 is a screen shot of a sample viewer application according to an illustrative embodiment of the present invention; and

FIG. 5 is a process flow diagram of a speech playback process according to illustrative embodiments of the present invention.

### DETAILED DESCRIPTION

Illustrative embodiments of the present invention provide three components, a mark-up application, an exporter application and a viewer application for providing speech-enabled text wherein spoken text is synchronously highlighted in a viewable document. The mark-up application is an intervention tool which allows a publisher to correct issues with the source document before it is exported. Examples of issues which may require intervention by the Publisher include, for example, Paragraph and sentence boundaries, text flow and reading order, alternative text and pronunciation.

The exporter application applies the mark-up information to the source document and produces an output document. The output document may be in any one of a number of formats, but the requirements for each format will be similar and will typically include an image of the source page (for example, a JPEG or Scalable Vector Graphics image), an audio representation of the text on the page (for example, an MP3 file), definitions of word locations, position of each word in the audio output, sentence information, flow information and (optionally) a text representation of the individual words (for example, in an XML file). These three outputs can be generally provided for each page of the source document, and will enable the creation of the required output.

The viewer application can be either an existing multimedia viewer application or a custom viewer application, for example. Output from the various illustrative embodiments of the can be distributed online or on portable media.

Embodiments of the present invention are designed as cross-platform solutions. For example, a video file output is generally portable because proprietary formats can generally be supported on a wide range of devices without requiring any additional software to be developed. A viewer application can also be generally portable. For example, if the viewer application is developed using a platform such as Macromedia Flash, then the Electronic Book can be viewed on any device which supports Flash. This includes Windows PCs, Apple Macintosh computers and handheld devices including some modern mobile telephones.

An illustrative embodiment of the present invention provides a process which covers the entire conversion from an existing digital electronic book (which can be in a variety of formats) to the creation of the output format, which can be a proprietary multimedia format or a custom format for use in a Viewer Application.

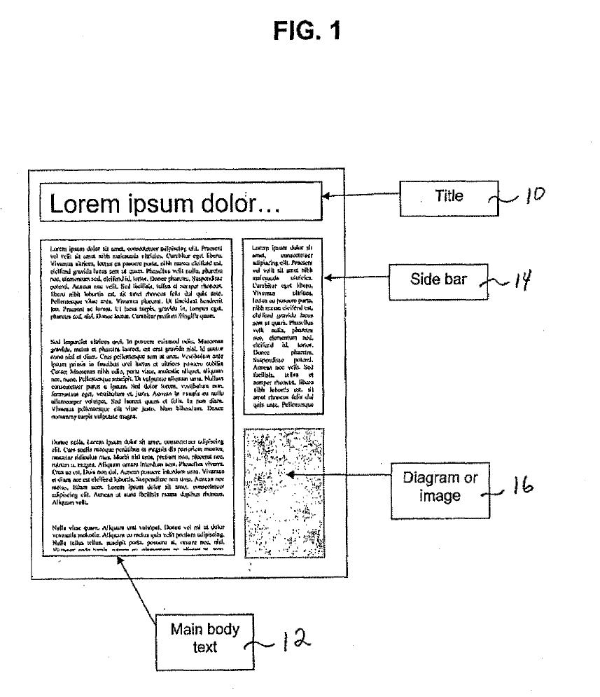

FIG. 1 illustrates certain elements on a typical page of an illustrative source document including a title 10, main body text 12, a side bar 14 and a diagram or image 16. The source document is typically an electronic document which can be a pre-existing document such as that created by a Publisher for a print book, for example or a document converted by optical character recognition techniques from an existing paper-based document, for example. Other common source document for use according to illustrative embodiments of the present invention include Portable Document Format (PDF) documents, Microsoft Word documents and HTML documents.

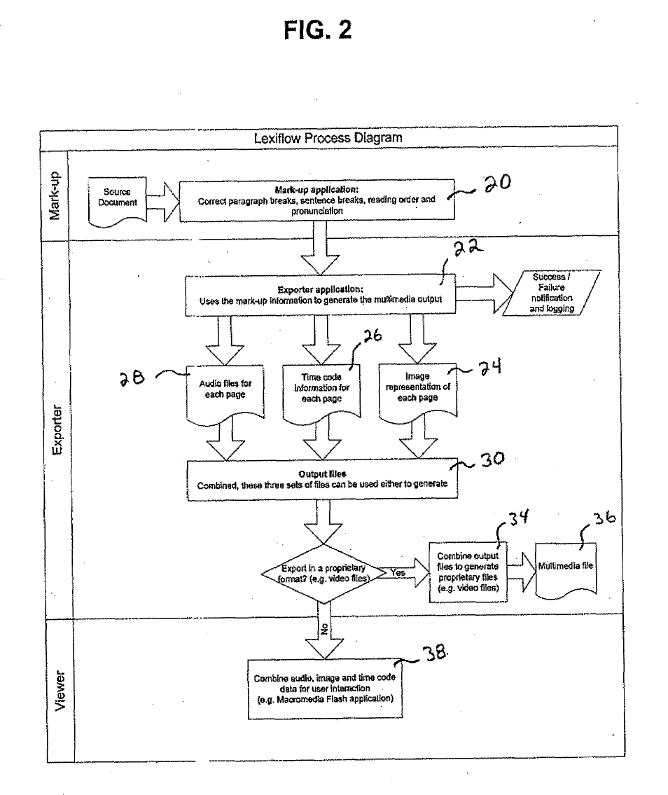

An illustrative process according to an embodiment of the present invention is described with reference to FIG. 2. A mark-up application 10 is provided which allows a publisher's intervention to improve the user experience with an exported book. Such intervention may include, for example, modification of paragraph and sentence boundaries, text flow, reading order, alternative text and pronunciation.

Paragraph and sentence boundary adjustments may be necessary when text breaking cannot be automatically obtained from the source document to the satisfaction of the Publisher. This can be particularly problematic with bullet lists and headings, which could affect pronunciation (especially pausing) for a Text To Speech Engine.

Adjustments to text flow and reading order may be necessary when it is not apparent from the source document what order the page should be read in. This is not generally an issue with simple, linear documents such as novels, where the flow can be calculated automatically. However, text flow is a more serious issue with more complex books intended for the educational market, for example. Such books will typically have pages including body text, photographs, diagrams and side-bars, where it is not possible to automatically determine a reasonable reading order. According to illustrative embodiments of the invention, a publisher can decide how and in what order these elements are read.

Alternative text may be required where the source document includes elements which are not actually text but which might need to be included in the spoken output. Examples of this include photographs, charts and graphs which are imbedded as an image which may not contain any text but wherein a publisher may add a textual description. Alternative text may also be added by a publisher to describe mathematical equations which may not read logically with a text-to-speech engine, for example. Also, alternative text may be added by a publisher to describe elaborate headings which, for example, are implemented as an image because they are not created using a normal font in the document. These elements can be assigned ‘alternative text’ in a similar fashion to images on web pages as known in the art. This will allow the publisher to include such elements in a speech flow along with normal text.

Adjustments to pronunciation, or alternative pronunciations may be necessary because text-to-speech engines do not generally provide accurate pronunciation of certain words. This is a particular problem with place names and scientific names, for example.

In order to accommodate pronunciations for words that are troublesome for text-to speech engines, a phonetic pronunciation can be provided. For example, the name “Pacino” will generally be pronounced as “pass-ino” by a text-to-speech engine without intervention. A possible phonetic replacement is “pachino”. Additionally, there can be issues with the same word being pronounced in different ways depending on context. For example, the word ‘read’ can be pronounced ‘red’ or ‘reed’. It is also possible to change the pronunciation of a word to induce a brief pause when one is not automatically included. For example, in the following list, there might not be an adequate pause after the initial letter:
A Earth
B Fire
C Water
   This may be read as “ay-earth, bee-fire, cee-water”. If the pronunciation was changed to add a period to each initial letter, the audio output will sound better but the appearance of the list will remain unchanged.

An exporter application 22 is described herein with reference to a PDF file according to an illustrative embodiment of the present invention. Persons having ordinary skill in the art should appreciate that similar processes can be used for various other formats within the scope of the present disclosure. In the illustrative embodiment, the exporter application provides three type of files for each page. The three file types include image files 24, time code files 26 and audio files which describing different aspects of each page in a speech-enabled book or document.

Image files 24 provide an image representation of each page in the document that can be used by the Viewer Application. Highlighting of words, sentences and paragraphs can be superimposed on this image either in the Viewer Application or as part of the creation of a proprietary video file. In one example, Adobe Acrobat can be used to mark-up a PDF file. The Acrobat SDK can provide a programmatic interface to Acrobat's own export functions which enable a page or series of pages to be saved in a variety of proprietary formats, such as JPEG image. Third-party applications can also be used to produce an export document in formats such as Scalable Vector Graphics, which offer a much higher quality than JPEG.

According to illustrative embodiments of the invention, audio files 28 can be generated using a text-to-speech engine such as Microsoft SAPI 5, for example. Text can be extracted from each page and sent to the text-to-speech engine. There may be more than one flow of text on a page, but the method is the same no matter how many flows there are. Output from the text-to-speech engine can be captured in an audio file 28. In the example of SAPI 5 speech, the audio file is normally captured as a WAV format file.

In the illustrative embodiments, timing information can then be extracted from the audio file. Alternatively, timing information can be extracted during generation of the audio file. This timing information can include a time code for each word in the audio file, code information can be stored for use in extraction of text for use in retrieval of text attributes in a viewer application.

Most proprietary document formats provide some sort of Document Object Model (DOM) that can be used to extract text from a document. The DOM generally includes the words themselves and positional and formatting information.

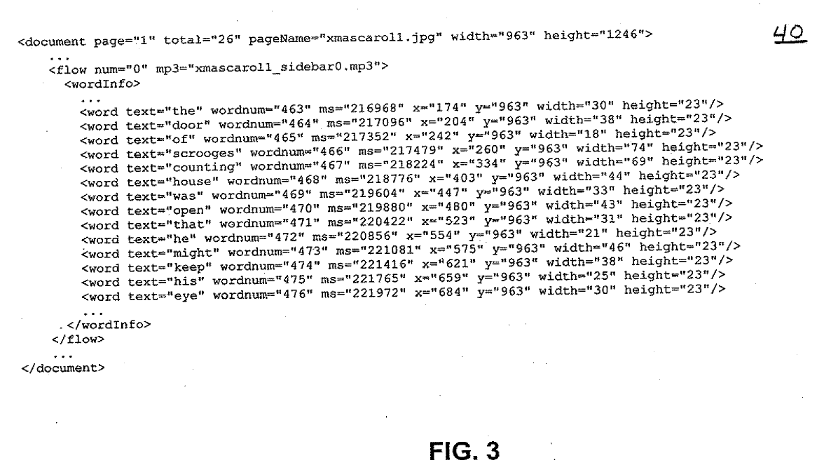

The information contained in the DOM can normally be summarised in a tree, with paragraphs containing a sequence of sentences, and sentences containing a sequence of words. Some DOMs (such as Adobe Acrobat's PDF handling) may not provide of these levels and require additional computation to calculate sentence and paragraph breaks, but the principles remain the same. FIG. 3 provides an example of simple DOM view 40 of a portion of a document.

The basic processing for text extraction according to an illustrative embodiment of the invention can be performed according to the following example of a text extraction algorithm using extended mark-up language (XML).

### For Each Page in the Document

Start new XML file for this page
Write page-level data to XML file:

```
  name of MP3 file associated with this page
  page number
  total number of pages
  any other required page-level information
  width and height of page image
```

For each paragraph in the page

Write paragraph-level data to XML file:

number of sentences in the paragraph
For each sentence in the paragraph:

Write sentence-level data to XML file:

number of words in the sentence

For each word in the sentence:

Write word-level data to XML file:

word text
bounding rectangle of word (x,y,w,h)
word number
offset of word from start of audio stream

End (For each word)

End (For each sentence)

End (for each paragraph)
For each hyperlink on the page

Write hyperlink data to. XML file:

```
  hyperlink destination (for example, the URL of a
  webpage)
  bounding rectangle of hyperlink (x, y, width, height)
```

End (for each paragraph)

End (for each page)

This exemplary algorithm assumes that XML is used to store the text data, wherein one XML file is used per page. It should be understood that this algorithm represents a simplified view of the text extraction process. For example, if there are multiple text flows for a single page, the process is repeated for each of the text flows.

In the text extraction steps, additional information such as hyperlinks can also be extracted from the page. It can also be necessary to extract additional information at word, sentence or paragraph level from a page. Furthermore, not all information may need to be stored for every application. For example, certain applications may not require storage of paragraph information because sentence delimiting information may be adequate in some cases.

Examples of XML files that can result from implementation of the exemplary algorithm and which demonstrate a basic structure of information that can be stored for a page are shown in Tables 1-3 below. Persons having ordinary skill in the art should appreciate that an XML file for a complete document would be many pages longer than this, but it consists of the same basic format throughout.

TABLE 1
Document Information Representing
the Current Page of the Document

| Attribute | Explanation |
|---|---|
| page | Current page number |
| total | Number of pages in the document |
| pageName | Name of the image file for this page |
| width | Width of the page image |
| height | Height of the page image |

TABLE 2
Flow Information Representing a Single
Reading Flow in the Current Page

| Attribute | Explanation |
|---|---|
| num | Flow index number |
| mp3 | Name of the audio file for this flow |
| pageName | Name of the image file for this page |
| width | Width of the page image |
| height | Height of the page image |

TABLE 3
Word Information Representing a Single Word in the Flow

| Attribute | Explanation |
|---|---|
| text | The English text of the word, if required |
| wordnum | Word number (from the start of the flow) |
| Ms | Offset of the word, in milliseconds, from the start of the |
| | audio file |
| x | X-coordinate of the word's bounding rectangle on the image |
| y | Y-coordinate of the word's bounding rectangle on the image |
| width | Width of the word's bounding rectangle on the image |
| height | Height of the word's bounding rectangle on the image |

Regarding Table 2, it should be understood that there can generally be multiple flows per page. Similarly, regarding Table 3, it should be understood that there will typically be many words in each flow. The words are generally presented in the order of speaking.

Referring again to FIG. 1, after audio files 28, time code information 26 and image representations 24 have been created for each page, these outputs can be combined in a combination step 30 for use in a viewer application

Illustrative embodiments of the present invention can be viewed using existing multimedia viewers. For example, output created by the exporter application 22 can be combined 34 and encoded as a computer multimedia file 36. To create the multimedia file, each page can be ‘played’ and recorded before conversion to the appropriate format. The multimedia file can be any proprietary computer video file, such as AVI video, MPEG video, Windows Media Video, Real Media, Quicktime or the like. The video can then be played back on any compatible player on any hardware platform that supports the format, including but not limited to a Windows PC or an Apple Macintosh. By extension, the MPEG output format can be transferred to Digital Versatile Disc for viewing in a domestic DVD player.

Output provided for existing multimedia viewers has the advantage of being substantially portable. However, such output does not allow a high level of user interaction. For example, user interaction can generally be limited to fast forwarding and rewinding through a video output.

Where the user requires greater control than a proprietary multimedia format can offer, a custom Viewer Application can be provided according to another illustrative embodiment of the invention. This type of viewer application can allow a user to control the reading of the Output in a far less linear fashion than required by proprietary video file formats.

The same three outputs from the export application 22: audio files 28, time code information 26 and image representations 24 can be used. The coordinates of any word on the page are known, and when the user selects a word (for example, by clicking with a mouse), it is possible to calculate which word is being selected, and where to start reading in the audio file. As the audio stream is played, each word can be highlighted to provide synchronised speech highlighting.

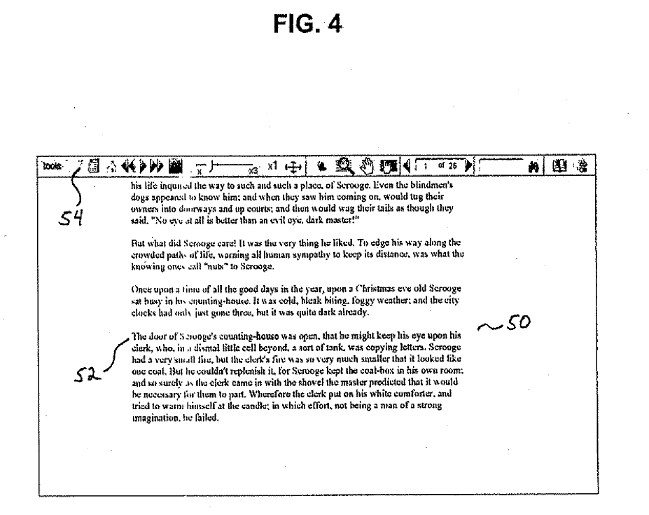

FIG. 4 is a screen shot of a sample viewer application according to an illustrative embodiment of the present invention. A document view 50 can include synchronised speech with highlighting 52 of text as it is being spoken. A toolbar 54 can include various controls for speech control, zooming and page navigation, and the like along with support utilities such as a calculator or dictionary, for example.

Additional functions that can be provided in a viewer application according to various illustrative embodiments of the present invention can allow a user to navigate forward or backwards at a sentence or paragraph level, continuously read the entire page or document with sentence by sentence highlighting and/or control more than one text flow. For example, in an illustrative embodiment, a user can choose if and when they want to read sidebars, diagrams and other secondary items. In illustrative embodiments, the viewer application zoom level can be changed to aid partially-sighted users or to clarify smaller detail. Other embodiments allow a user to use hyperlinks embedded in the document to navigate to other pages or to external web sites. Yet another embodiment of the invention provides reading support tools such as a dictionary or translation utility in the viewer application.

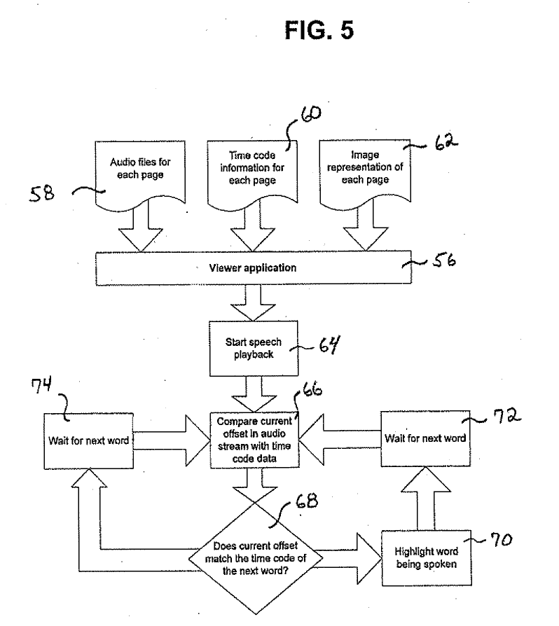

FIG. 5 is a flowchart which shows the inputs used and the sequence of events which occur during speech playback, either inside a viewer application or during the generation of a proprietary format such as a video file according to an illustrative embodiment of the invention. It should be understood by persons having ordinary skill in the art that a video file differs from a custom viewer application in that video files require capturing and encoding images and audio using a video encoder such as Windows Media, Realmedia or Quicktime, for example.

In the illustrative embodiment, the viewer application 56 receives audio files for each page 58, time code information for each page 60 and an image representation of each page 62 from an exporter application (not shown). When the viewer application starts a speech playback 64, it compares 66, 68 a current offset in the audio stream (time from start or reference point) with time code data 60. If the current offset matches the time code associated with the next word to be read, the word being spoken is highlighted 70 on the image representation of the page and the viewer application 56 waits for the next word 72. If the current offset does not match the time code associated with the next word to be read, the viewer application 56 waits for the next word 74.

Illustrative embodiments of the invention provide speech-playback output which can be distributed on-line or on portable media. The viewer application may be created using a web-based technology such as Macromedia Flash, for example. Users can then navigate to a supplied URL. By distributing output on-line, no installation of client software is required (other than Flash, which most modern personal computers will have preloaded). Audio, video and mark-up data can be downloaded as required so a user can interact with the document as described herein. On-line distribution also allows access to the online nominated users.

Alternatively, video files, viewer applications and/or associated files can be authored to DVD or CD for distribution. In an illustrative embodiment, such a disc can be included in textbooks along with other support materials, as is common practice in the publishing industry. Portable media distribution is generally similar to on-line distribution without requiring an internet connection. A user can access the files directly from the disc, for example, or the viewer application and multimedia files can be copied to a location on a network to permit multiple users to access the book.

An illustrative embodiment of the invention allows a user to define the flow or reading order of a PDF file for example. PDF files can be made up of a number of zones. These zones can contain text or graphics. The product will follow the text flow from one zone to another as defined by the original publisher of the PDF document. In some complex documents the text flow defined by the publishing environment (e.g. Quark) may not be ideal for text to speech scenarios, especially if the file has had much post production work done. For this reason, it can be desirable to redefine the reading order of any page. For speed and simplicity the zones can be defined as paragraphs. A paragraph may be a heading, a header or a footer as well as main body text in the document, for example. Any paragraph can be omitted from the main text flow in the document. In this way authors can precisely control the reading order of the page, and can exclude headers and footers from the text flow.

A zone file can be stored in an ANSI text file with the file extension “.flow” for example.

An illustrative zone file can be machine readable by Windows. The zone file can include a section for each page in a document. Each page can contain a list of paragraph references corresponding to paragraphs in the document object model. A linked list order can define auto-continue, forward and backward reading orders. Paragraphs that are in the document object model that are not referenced in the linked list can be treated as speakable text that is not part of the text flow. In addition each page can include an array of rectangular regions. If the user attempts to use the click and speak tool within one of the defined rectangular regions it will be non functional.

In an illustrative embodiment of the invention a zoning tool can be used to define a preferred reading order for any given page of a document. When the reading order has been defined, it can be saved to the zone file.

For efficiency purposes the zone file can be a separate external file. An illustrative zoning tool can define three key types of zones:

i) The desired text flow—paragraphs that should be spoken as the main text flow of the document, and their place in a defined order of such paragraphs;

ii) Speakable text which is not part of the text flow. Auto-continue will generally not function when these paragraphs are clicked; and

iii) Non Speaking Zones—Rectangles inside which the speech functionality is disabled—or speaks a text string defined by the publisher.

Zone files can be identified by the same prefix as the pdf file to which they refers, and can have the extension “.flow”.

An illustrative embodiment of the invention can compensate for a speech engine's incorrect pronunciations by responding to an optional external pronunciation file to fine tune the pronunciation of specific words. This file can be identified with the same prefix as the pdf file to which it refers, and can have the extension “.pron” for example. An illustrative pronunciation file can be an ANSI text file that is machine readable by Mac (OS9 and OSX) and Windows and be provided in a simple format such as:

<start of file>
pacino=pachino
word1=word2
word3=word4 <end
of file>

In an illustrative embodiment of the invention, a user will have the ability to add or remove sentence breaks. These sentence breaks will cause the speech engine to pause between sentences.

Images and rectangles on a page can have some descriptive text associated with them. In an illustrative embodiment, a user can define a rectangle on the page using the Alt Text Control, for example, and can be prompted to enter text to associate with the rectangle. This associated text effectively becomes a paragraph of text that can be fitted into the text flow.

Although the invention has been shown and described with respect to exemplary embodiments thereof, various other changes, omissions and additions in the form and detail thereof may be made therein without departing from the spirit and scope of the invention.

What is claimed is:

1. A system for converting text information to speech, comprising a markup application adapted for adding speech flow information to a source file to generate a marked up file, said markup application comprising:
a publishers interface;
editing means for defining paragraph breaks and sentence breaks;
editing means for modifying pronunciation of words in the source file;
editing means for adding words to the source file; and
editing means for defining a reading order of words in the marked up file.

2. The system according to claim 1 wherein the markup application is adapted for adding words to describe non-text elements of the source file.

3. The system according to claim 1 further comprising an exporter application adapted for receiving the marked up file from the markup application and generating audio files, time code information and image files therefrom.

4. The system according to claim 2 wherein the exporter application combines the audio files, timing code information and image files into an output format playable as speech with sequentially highlighted text on a video application.

5. A system for converting information into speech comprising:
a source file;
a mark-up application receiving the source file, wherein said mark-up application provides a publisher interface for adding flow information to the source file to provide a marked up file; and
an exporter application receiving said marked up file and generating audio files, time code information and image files therefrom.

6. The system according to claim 5 wherein said flow information comprises paragraph breaks, sentence breaks and reading order of text in said source file.

7. The system according to claim 5 wherein said markup application is adapted for modifying pronunciation of words in said source file.

8. The system according to claim 5 wherein said markup application is adapted for adding words to describe non-text elements of the source file.

9. The system according to claim 5 wherein said time code information includes a time for each word to be spoken relative to a reference time.

10. The system according to claim 5 wherein said exporter application combines said audio files, time code information and image files to generate a multimedia file.

11. The system according to claim 5 wherein said exporter application combines said audio files, time code information and image files for user interaction in a viewer application.

12. The system according to claim 11 wherein said viewer application comprises a multimedia flash application.

13. A method for converting information into speech comprising:
providing a publisher for receiving a source file and adding speech flow information to said source file to form a marked up file;
generating an audio file, time code information, and an image file from said marked up file; and
combining said audio file, time code information and image file to generate an audiovisual output including a spoken representation of said source file and a viewable representation of said source file.

14. The method according to claim 13 wherein said flow information comprises paragraph breaks, sentence breaks and reading order of text in said source file.

15. The method according to claim 13 wherein said markup application is adapted for modifying pronunciation of words in said source file.

16. The system according to claim 13 wherein said markup application is adapted for adding words to describe non-text elements of the source file.

17. The system according to claim 13 wherein said time code information includes a time for each word or phoneme to be spoken relative to a common a reference time.

18. The method according to claim 13 wherein the viewable representation includes text portions that are highlighted in synchronization with said spoken representation.

19. The method according to claim 13 wherein said audiovisual output comprises a multimedia file.

20. The method according to claim 13 further comprising providing an viewer application for receiving said audiovisual output, wherein said viewer application provides an interface for user interaction with said audiovisual output.
